(19) United States
(12) Patent Application Publication
(10) Pub. No.: US 2012/0001591 A1
(43) Pub. Date: Jan. 5, 2012

(54) POWER SUPPLY APPARATUS, POWER SUPPLY SYSTEM, CONTROL METHOD, AND STORAGE MEDIUM

(75) Inventor: Yudai Fukaya, Tokyo (JP)

(73) Assignee: CANON KABUSHIKI KAISHA, Tokyo (JP)

(21) Appl. No.: 13/162,997

(22) Filed: Jun. 17, 2011

(30) Foreign Application Priority Data
Jun. 30, 2010 (JP) 2010-150260

(51) Int. Cl. H02J 7/00

(52) U.S. Cl. 320/108

(57) ABSTRACT

A power supply apparatus for supplying electric power wirelessly to a power receiving apparatus which charges a battery, informs information indicating a remaining capacity corresponding to the power receiving apparatus, if the power receiving apparatus is moved.

### BACKGROUND OF THE INVENTION

1. Field of the Invention

The present invention relates to a power supply apparatus which supplies electric power to a power receiving apparatus, a power supply system, a control method, and a storage medium.

2. Description of the Related Art

In recent years, a technique about a power supply system having a power receiving apparatus which charges a rechargeable battery, and a power supply apparatus which supplies electric power to the power receiving apparatus in a non-contact manner without any connection means such as a connector, is known. In such a non-contact power supply system, the power supply apparatus has a primary coil, and the power receiving apparatus has a secondary coil. The power supply apparatus supplies electric power to the power receiving apparatus in a non-contact manner using electromagnetic induction by the primary and secondary coils, and the power receiving apparatus charges a rechargeable battery by electric power supplied from the power supply apparatus.

A power supply apparatus which can supply electric power to a plurality of power receiving apparatuses placed on the power supply apparatus in such non-contact power supply system has been disclosed (Japanese Patent Laid-Open No. 2007-89341).

However, for example, when the power supply apparatus supplies electric power to the plurality of power receiving apparatuses, the user cannot recognize the charging states of the plurality of power receiving apparatuses. For this reason, the user cannot detect whether or not charging of a desired power receiving apparatus is complete.

### SUMMARY OF THE INVENTION

The present invention allows the user to detect a charging state of a desired power receiving apparatus.

According to an aspect of the present invention, there is provided a power supply apparatus for supplying electric power wirelessly to a power receiving apparatus which charges a battery, the power supply apparatus comprising: a detection unit that detects whether or not the power receiving apparatus is moved based on motion information associated with a motion of the power receiving apparatus; and a control unit that controls an informing unit to inform remaining capacity information indicating a remaining capacity of the battery if it is detected that the power receiving apparatus is moved, wherein the motion information and the remaining capacity information are obtained from the power receiving apparatus.

Further features of the present invention will become apparent from the following description of exemplary embodiments with reference to the attached drawings.

### BRIEF DESCRIPTION OF THE DRAWINGS

FIG. 1 is a perspective view showing an example of a power supply system according to the first and second embodiments of the present invention;

FIG. 2 is a block diagram showing an example of a power supply apparatus according to the first and second embodiments of the present invention;

FIG. 3 is a graph showing charging states of the power supply apparatus according to the first and second embodiments of the present invention;

FIG. 4 is a block diagram showing an example of a power receiving apparatus according to the first and second embodiments of the present invention;

FIGS. 5A and 5B are flowcharts showing an example of process to be executed by the power supply apparatus and power receiving apparatus according to the first embodiment of the present invention; and

FIGS. 6A and 6B are flowcharts showing an example of processing to be executed by the power supply apparatus and power receiving apparatus according to the second embodiment of the present invention.

### DESCRIPTION OF THE EMBODIMENTS

Exemplary embodiments of the present invention will now be described in detail in accordance with the accompanying drawings.

### First Embodiment

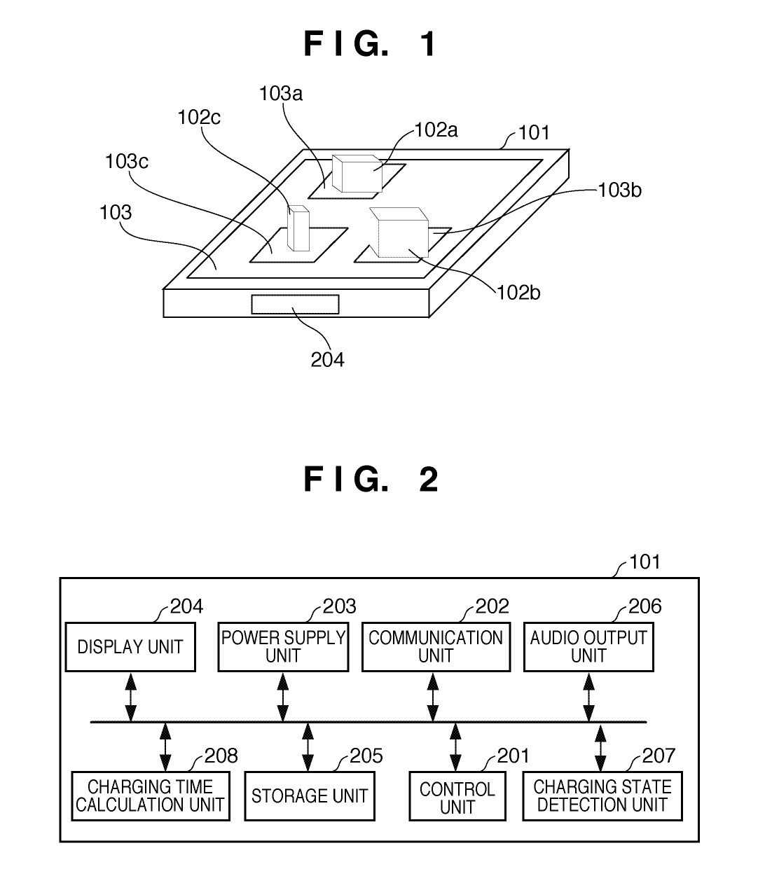

FIG. 1 is a perspective view showing a non-contact power supply system according to the first and second embodiments of the present invention. The non-contact power supply system has a power supply apparatus 101 which supplies electric power in a non-contact manner, and a plurality of power receiving apparatuses 102a to 102c which charge their rechargeable batteries (secondary batteries) by using electric power supplied from the power supply apparatus 101. The plurality of power receiving apparatuses 102a to 102c shown in FIG. 1 include a mobile phone 102a, digital camera 102b, and digital video camera 102c. The mobile phone 102a, digital camera 102b, and digital video camera 102c respectively have rechargeable batteries which are charged by using electric power received from the power supply apparatus 101 in a non-contact manner. The power supply apparatus 101 can simultaneously supply electric power to the mobile phone 102a, digital camera 102b, and digital video camera 102c in a non-contact manner. The power receiving apparatuses 102a to 102c can be placed on a power supply area 103 on its supper surface of the power supply apparatus 101. The power supply apparatus 101 can simultaneously supply electric power to one or a plurality of power receiving apparatuses 102a to 102c placed within the power supply area 103.

The power supply apparatus 101 has a display unit 204 which displays a charging state of one of the mobile phone 102a, digital camera 102b, and digital video camera 102c placed on the power supply area 103. Note that the power supply area 103 is a predetermined range in which the power supply apparatus 101 can supply electric power to the plurality of power receiving apparatuses 102a to 102c (that is, a predetermined range in which the plurality of power receiving apparatuses 102a to 102c can receive electric power from the power supply apparatus 101). The plurality of power receiving apparatuses 102a to 102c which exist within the power supply area 103 of the power supply apparatus 101 can charge their rechargeable batteries by electric power supplied from the power supply apparatus 101. Since the plurality of power receiving apparatuses 102a to 102c which do not exist within the power supply area 103 of the power supply apparatus 101 cannot receive electric power supplied from the power supply apparatus 101, they cannot charge their rechargeable batteries.

Assume that when the plurality of power receiving apparatuses 102a to 102c are placed within the power supply area 103 of the power supply apparatus 101, they exist within the power supply area 103. Also, assume that when the plurality of power receiving apparatuses 102a to 102c are not placed within the power supply area 103 of the power supply apparatus 101, they do not exist within the power supply area 103.

FIG. 2 is a block diagram showing the power supply apparatus 101. The power supply apparatus 101 has a control unit 201, a communication unit 202, a power supply unit 203, the display unit 204, a storage unit 205, an audio output unit 206, a charging state detection unit 207, and a charging time calculation unit 208.

The control unit 201 has, for example, a CPU, RAM, and ROM, and controls the respective units of the power supply apparatus 101 when the CPU executes programs stored in the ROM.

The communication unit 202 is controlled by the control unit 201, and makes wireless communications with the plurality of power receiving apparatuses 102a to 102c by a wireless communication method such as a wireless LAN or near field wireless communication. The communication unit 202 acquires, from the plurality of power receiving apparatuses 102a to 102c, motion information as information associated with a motion of one of the plurality of power receiving apparatuses 102a to 102c and charging state information indicating a charging state of one of the plurality of power receiving apparatuses 102a to 102c. The communication unit 202 supplies the motion information acquired from one of the plurality of power receiving apparatuses 102a to 102c at least to the storage unit 205, and supplies the charging state information acquired from one of the plurality of power receiving apparatuses 102a to 102c at least to the charging state detection unit 207. The communication unit 202 can also transmit charging start information required to start charging to the power receiving apparatuses 102a to 102c. In the first embodiment, the communication unit 202 individually communicates with the power receiving apparatuses 102a to 102c using a communication method of the wireless LAN communication standard such as IEEE802.11a, b, or g. Note that the communication unit 202 may communicate with the power receiving apparatuses 102a to 102c by a communication method other than the communication method of the wireless LAN communication standard such as IEEE802.11a, b, or g.

The power supply unit 203 starts to charge the plurality of power receiving apparatuses 102a to 102c placed on the power supply area 103 in a non-contact manner after the communication unit 202 transmits the charging start information to them. Thus, the power receiving apparatuses 102a to 102c, which received the charging start information, begin to charge their rechargeable batteries. “Non-contact power supply” in the first embodiment is a power supply method which performs power transmission from the power supply apparatus 101 to the plurality of power receiving apparatuses 102a to 102c without any contacts such as connectors and terminals. As the non-contact power supply method in the first embodiment, an electromagnetic induction type will be exemplified. Alternatively, a non-contact power supply method other than the electromagnetic induction type, that is, one of electric field resonance type, resonant magnetic coupling type, and electric wave type may be used.

The power supply unit 203 has a plurality of power supply zones 103a to 103c on the power supply area 103, and can independently control power supply operations for respective power supply zones 103a to 103c. When the electromagnetic induction type is adopted as the non-contact power supply method, a plurality of primary coils are arranged in correspondence with the power supply zones 103a to 103c, and the power supply unit 203 individually controls electric powers to be supplied to the power receiving apparatuses 102a to 102c on the individual power supply zones 103a to 103c. Note that the control unit 201 can individually control electric powers to be supplied to the power receiving apparatuses 102a to 102c by associating pieces of identification information (apparatus IDs) acquired from the power receiving apparatuses 102a to 102c with the power supply zones 103a to 103c.

Note that when the resonant magnetic coupling type is adopted as the non-contact power supply method, a plurality of antennas are arranged in correspondence with the power supply zones 103a to 103c, and the power supply unit 203 individually controls electric powers on the individual power supply zones 103a to 103c.

The display unit 204 includes, for example, a liquid crystal display or LED, and displays charging states of the power receiving apparatuses 102a to 102c. Also, the display unit 204 displays, for example, apparatus IDs of the power receiving apparatuses 102a to 102c placed on the power supply area 103 in addition to the charging states of the power receiving apparatuses 102a to 102c.

The storage unit 205 is used as a work area required for the control unit 201 to execute programs, and as an area used to store information received when the communication unit 202 performs a wireless communication.

The audio output unit 206 includes, for example, a loudspeaker. The audio output unit 206 outputs audio data corresponding to the charging state of one of the power receiving apparatuses 102a to 102c.

The charging state detection unit 207 detects power consumption consumed by one of the power receiving apparatuses 102a to 102c selected as a power supply target when the power supply unit 203 supplies electric power to one of the power receiving apparatus 102a to 102c selected as a power supply target from the power receiving apparatuses 102a to 102c. Note that power consumption consumed by one of the power receiving apparatuses 102a to 102c selected as a power supply target when the power supply unit 203 supplies electric power includes electric power used to charge its rechargeable battery in one of the power receiving apparatuses 102a to 102c. The charging state detection unit 207 also detects charging state of the power receiving apparatus as a power supply target based on the detected power consumption.

Detection of the charging state of the power receiving apparatus 102 will be described below. A case will be exemplified below wherein the power supply unit 203 supplies electric power to the power receiving apparatus 102a.

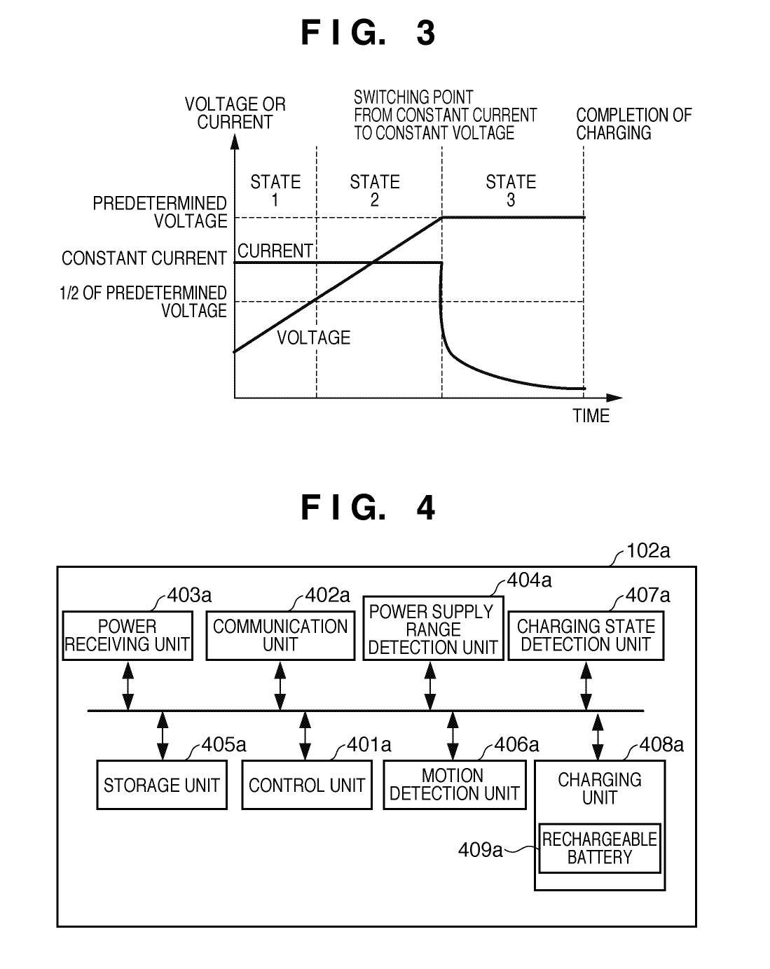

FIG. 3 is a graph showing an example of temporal changes in current and voltage to be supplied to a rechargeable battery 409a in the power receiving apparatus 102a when the power supply unit 203 supplies electric power to the power receiving apparatus 102a as a power supply target. Note that a voltage required for the power receiving apparatus 102a as a power supply target to charge the rechargeable battery 409a by electric power supplied from the power supply apparatus 101 will be referred to as “charging voltage” hereinafter, and a current required for the power receiving apparatus 102a to charge the rechargeable battery 409a will be referred to as “charging current” hereinafter. The abscissa of FIG. 3 represents a time axis which indicates an elapsed time elapsed since the communication unit 202 transmits the charging start information, and the ordinate of FIG. 3 is a current axis which indicates a charging current value and a voltage axis which indicates a charging voltage value.

When the power supply apparatus 101 transmits the charging start information to the power receiving apparatus 102a as a power supply target, and starts a power supply operation to the power receiving apparatus 102a, the power receiving apparatus 102a executes constant current control required to control a charging current supplied from a charging unit 408a to the rechargeable battery 409a to have a predetermined current value. When the power receiving apparatus 102a executes the constant current control, a charging voltage supplied from the charging unit 408a to the rechargeable battery 409a rises along with an elapse of the elapsed time. When the charging voltage to the rechargeable battery 409a is equal to or more than a predetermined voltage value after the constant current control, the power receiving apparatus 102a executes constant voltage control required to control the charging voltage to the rechargeable battery 409a to have a predetermined voltage value. When the power receiving apparatus 102a executes the constant voltage control, the charging current supplied to the rechargeable battery 409a falls along with an elapse of the time. Upon completion of charging of the rechargeable battery 409a in the power receiving apparatus 102a as a power supply target, a value of the charging current supplied to the rechargeable battery 409a becomes nearly zero. In this way, the power receiving apparatus 102a consumes power consumption according to the product of the charging current and charging voltage so as to charge the rechargeable battery 409a. The charging state detection unit 207 can detect power consumption consumed by the power receiving apparatus 102a, and can detect a charging state indicating charging of the rechargeable battery 409a by the power receiving apparatus 102a as a power supply target in accordance with the detected power consumption.

The charging state includes four states. Note that these four states will be described below.

In the first embodiment, as shown in FIG. 3, when the power receiving apparatus 102a executes the constant current control, a state in which the charging voltage assumes a value less than a half of a predetermined voltage value is defined as “state 1”. When the power receiving apparatus 102a executes the constant current control, a state in which the charging voltage assumes a value which is equal to or larger than the half of the predetermined voltage value and is less than the predetermined voltage value is defined as “state 2”. When the power receiving apparatus 102a executes the constant voltage control, a state in which the charging voltage assumes a value equal to or larger than the predetermined voltage value is defined as “state 3”. When the power receiving apparatus 102a executes the constant voltage control, a state in which the charging current is equal to or less than a current value indicating completion of charging is defined as a “state 4 (completion of charging)”. In this way, the charging state detection unit 207 can determine one of the four states as the charging state of the power receiving apparatus 102a as a power supply target according to the power consumption consumed by the power receiving apparatus 102a.

Note that the predetermined current value and predetermined voltage value are those which are decided by the power receiving apparatus 102a, and the power receiving apparatus 102a controls charging by changing the predetermined current value and predetermined voltage value. A current value indicating completion of charging assumes a value nearly equal to zero, and is decided by the power receiving apparatus 102a. For example, when the detected power consumption is nearly zero, the charging state detection unit 207 determines that the charging state of the power receiving apparatus as a power supply target is “state 4”. Note that the predetermined current value and predetermined voltage value may be decided in advance or may be changed when the user operates the power receiving apparatus 102a. Note that the power receiving apparatuses 102b and 102c perform charging in the same manner as in the power receiving apparatus 102a, and the charging state detection unit 207 can detect a charging state of one of the power receiving apparatuses 102b and 102c as in the power receiving apparatus 102a.

Also, when the charging state detection unit 207 receives charging state information received by the communication unit 202, it analyzes the charging state information, and can detect a charging state of a power receiving apparatus based on the analysis result.

The charging time calculation unit 208 calculates an elapsed time as a time period elapsed since transmission of the charging start information.

FIG. 4 is a block diagram showing an example of the arrangement of the power receiving apparatus 102a. The power receiving apparatus 102a has a control unit 401a, a communication unit 402a, a power receiving unit 403a, a power supply range detection unit 404a, a storage unit 405a, a motion detection unit 406a, a charging state detection unit 407a, and the charging unit 408a. Note that the rechargeable battery 409a detachable from the power receiving apparatus 102a is connected to the charging unit 408a.

The control unit 401a has, for example, a CPU, RAM, and ROM, and controls the respective units of the power receiving apparatus 102a when the CPU executes programs stored in the ROM.

The communication unit 402a is controlled by the control unit 401a, makes a wireless communication with the power supply apparatus 101 by, for example, a wireless LAN, and transmits motion information and charging state information of the power receiving apparatus 102a to the power supply apparatus 101. The communication unit 402a can receive the charging start information and charging stop information transmitted from the power supply apparatus 101.

When the communication unit 402a receives the charging start information, the power receiving unit 403a receives electric power supplied from the power supply unit 203 of the power supply apparatus 101, and supplies the received electric power to the charging unit 408a. The charging unit 408a charges the rechargeable battery 409a by executing the constant current control and constant voltage control based on electric power supplied from the power receiving unit 403a, as described above.

The power supply range detection unit 404a detects whether or not a distance between the power receiving apparatus 102a and power supply apparatus 101 exists within a power supply range. The power supply range is a predetermined range in which the power receiving apparatus 102a can receive electric power from the power supply apparatus 101 in a non-contact manner. The power supply range detection unit 404a detects whether or not the power receiving apparatus 102a exists within the power supply range of the power supply apparatus 101 by checking whether or not a predetermined electric power supplied from the power supply apparatus 101 is detected via the power receiving unit 403a. Assume that when the power receiving apparatus 102a is placed on the power supply apparatus 101, the power supply range detection unit 404a detects that the power receiving apparatus 102a exists within the power supply range of the power supply apparatus 101. Also, assume that when the power receiving apparatus 102a is not placed on the power supply apparatus 101, the power supply range detection unit 404a detects that the power receiving apparatus 102a does not exist within the power supply range of the power supply apparatus 101.

The storage unit 405a is used as a work area required for the control unit 401a to execute programs, and as an area used to store information received when the communication unit 402a performs a wireless communication. The storage unit 405a stores an apparatus ID as identification information required to identify the power receiving apparatus 102a.

The motion detection unit 406a detects, using, for example, a gyro sensor, whether or not the power receiving apparatus 102a has been physically moved. In this case, for example, when the power receiving apparatus 102a has been moved by being rotated through a predetermined angle (for example, 5°) or more, or when a predetermined acceleration has been continuously detected for a predetermined time period (for example, 0.5 sec) or longer, the motion detection unit 406a detects that the power receiving apparatus 102a has been physically moved. Conditions required to detect whether or not the power receiving apparatus 102a has been physically moved are appropriately set in consideration of, for example, the types of sensors used by the motion detection unit 406a, and a balance between suppression of detection errors and required detection precision. When the motion detection unit 406a detects that the power receiving apparatus 102a has been physically moved, the control unit 401a detects the charging state of the rechargeable battery 409a via the charging state detection unit 407a. When the motion detection unit 406a detects that the power receiving apparatus 102a has been physically moved, it supplies motion information indicating detection of a motion to the communication unit 402a.

Also, the motion detection unit 406a may detect whether or not the power receiving apparatus 102a has been physically moved by determining whether or not the power receiving apparatus 102a is in a still state.

The charging state detection unit 407a detects the charging current and charging voltage supplied from the charging unit 408a to the rechargeable battery 409a. The charging state detection unit 407a detects a charging capacity of the rechargeable battery 409a. The charging capacity of the rechargeable battery 409a is information indicating a remaining capacity of the rechargeable battery 409a with respect to the full charging state. As a method of detecting the charging capacity of the rechargeable battery 409a by the charging state detection unit 407a, the charging capacity of the rechargeable battery 409a may be detected with reference to a table which associates the charging current and charging voltage detected by the charging state detection unit 407a with the charging capacity of the rechargeable battery 409a. As another method of detecting the charging capacity of the rechargeable battery 409a by the charging state detection unit 407a, the charging state detection unit 407a may calculate the charging capacity of the rechargeable battery 409a. As still another method of detecting the charging capacity of the rechargeable battery 409a by the charging state detection unit 407a, the charging state detection unit 407a may acquire the charging capacity detected by the rechargeable battery 409a. The charging state detection unit 407a supplies charging state information indicating the charging capacity of the rechargeable battery 409a to the communication unit 402a, which transmits this information to the power supply apparatus 101.

The charging unit 408a supplies electric power received by the power receiving unit 403a to the rechargeable battery 409a attached to the power receiving apparatus 102a, thereby charging the rechargeable battery 409a.

The arrangement of the power receiving apparatus 102a has been explained. Assume that the power receiving apparatuses 102b and 102c have the same arrangement as that of the power receiving apparatus 102a. Note that the power receiving apparatus 102b has a control unit 401b, a communication unit 402b, a power receiving unit 403b, a power supply range detection unit 404b, a storage unit 405b, a motion detection unit 406b, a charging state detection unit 407b, and a charging unit 408b. Note that the arrangement of the power receiving apparatus 102b is the same as that of the power receiving apparatus 102a. Note that the power receiving apparatus 102c has a control unit 401c, a communication unit 402c, a power receiving unit 403c, a power supply range detection unit 404c, a storage unit 405c, a motion detection unit 406c, a charging state detection unit 407c, and a charging unit 408c. Note that the arrangement of the power receiving apparatus 102c is the same as that of the power receiving apparatus 102a.

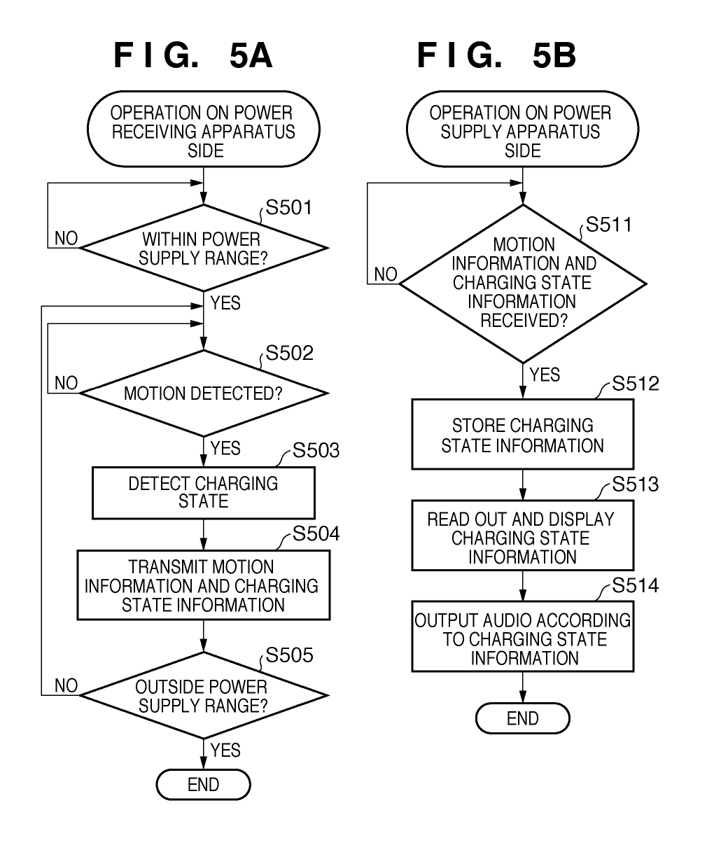

FIG. 5A is a flowchart for explaining motion detection process executed by one of the power receiving apparatuses 102a to 102c according to the first embodiment at least.

Assume that when the power receiving apparatuses 102a to 102c execute motion detection process, communication connections have already been established between the communication units 402a to 402c and the communication unit 202. Note that a case will be exemplified below wherein the power receiving apparatus 102a executes motion detection process.

In a power supply mode to the power receiving apparatus 102a, the power supply apparatus 101 controls the communication unit 202 to transmit the charging start information to the power receiving apparatus 102a, and controls the power supply unit 203 to transmit a predetermined electric power required to charge to the power receiving apparatus 102a.

When the power receiving apparatus 102a receives the charging start information from the power supply apparatus 101, it confirms whether or not the self apparatus exists within the power supply range of the power supply apparatus 101.

Hence, the control unit 401a determines in step S501 whether or not the power supply range detection unit 404a detects that the power receiving apparatus 102a exists within the power supply range of the power supply apparatus 101. The power supply range detection unit 404a can determine whether or not the power receiving apparatus 102a exists within the power supply range by checking whether or not the power receiving unit 403a receives the predetermined electric power supplied from the power supply apparatus 101. When the power receiving unit 403a receives the predetermined electric power supplied from the power supply apparatus 101, the power supply range detection unit 404a detects that the power receiving apparatus 102a exists within the power supply range. In this case, the control unit 401a determines that the power receiving apparatus 102a exists within the power supply range of the power supply apparatus 101. When the power receiving unit 403a does not receive any predetermined electric power supplied from the power supply apparatus 101, the power supply range detection unit 404a detects that the power receiving apparatus 102a does not exist within the power supply range. In this case, the control unit 401a determines that the power receiving apparatus 102a does not exist within the power supply range of the power supply apparatus 101.

When the control unit 401a determines that the power receiving apparatus 102a exists within the power supply range of the power supply apparatus 101, it controls the power receiving unit 403a to supply electric power received from the power supply unit 203 of the power supply apparatus 101 to the rechargeable battery 409a. In this case, the control unit 401a begins to charge the rechargeable battery 409a by electric power supplied from the power supply unit 203 via the power receiving unit 403a. When the control unit 401a begins to charge the rechargeable battery 409a, it controls the charging state detection unit 407a to detect the charging current and charging voltage of the rechargeable battery 409a, and also controls the motion detection unit 406a to detect a motion of the power receiving apparatus 102a. When the control unit 401a determines that the power receiving apparatus 102a does not exist within the power supply range of the power supply apparatus 101, it controls the power receiving unit 403a not to supply electric power received from the power supply unit 203 of the power supply apparatus 101 to the rechargeable battery 409a.

When the control unit 401a determines that the power receiving apparatus 102a exists within the power supply range, this process advances from step S501 to step S502. When the control unit 401a determines that the power receiving apparatus 102a does not exist within the power supply range, this process returns from step S501 to step S501.

The control unit 401a determines in step S502 whether or not the motion detection unit 406a has detected a motion of the power receiving apparatus 102a.

Motion information of the power receiving apparatus 102a detected by the motion detection unit 406a is supplied to the control unit 401a. The control unit 401a determines whether or not the power receiving apparatus 102a has been moved based on the supplied motion information of the power receiving apparatus 102a.

When the motion detection unit 406a has detected the motion of the power receiving apparatus 102a, that is, when the power receiving apparatus 102a has been moved, this process advances from step S502 to step S503. When the motion detection unit 406a has not detected any motion of the power receiving apparatus 102a, that is, when the power receiving apparatus 102a has not been moved, this process returns from step S502 to step S502.

In step S503, the control unit 401a controls the charging state detection unit 407a to detect the charging capacity of the rechargeable battery 409a.

The charging state detection unit 407a supplies the detected charging capacity of the rechargeable battery 409a to the control unit 401a. When the charging capacity of the rechargeable battery 409a is supplied to the control unit 401a, this process advances from step S503 to step S504.

In step S504, the control unit 401a reads out the apparatus ID stored in the storage unit 405a. The control unit 401a supplies the apparatus ID to the communication unit 402a together with the motion information supplied from the motion detection unit 406a and charging state information including the charging capacity of the rechargeable battery 409a supplied from the charging state detection unit 407a.

The control unit 401a controls the communication unit 402a to transmit the apparatus ID, motion information, and charging state information to the power supply apparatus 101. When the communication unit 402a transmits the apparatus ID, motion information, and charging state information to the power supply apparatus 101, this process advances from step S504 to step S505.

The control unit 401a determines in step S505 whether or not the power receiving apparatus 102a exists within the power supply range of the power supply apparatus 101, as in step S501. When the power receiving unit 403a does not receive any predetermined electric power supplied from the power supply apparatus 101, the control unit 401a determines that the power receiving apparatus 102a does not exist within the power supply range. When the power receiving unit 403a receives the predetermined electric power supplied from the power supply apparatus 101, the control unit 401a determines that the power receiving apparatus 102a exists within the power supply range.

When the control unit 401a determines that the power receiving apparatus 102a exists within the power supply range, this process returns from step S505 to step S502. When the control unit 401a determines that the power receiving apparatus 102a does not exist within the power supply range, this process ends. Note that when a communication connection between the communication unit 402a and the power supply apparatus 101 is disconnected, the control unit 401a ends the process.

Assume that in the first embodiment, when the user holds the power receiving apparatus 102a in air, the motion detection unit 406a does not detect any motion of the power receiving apparatus 102a. Also, note that the aforementioned motion detection process shown in FIG. 5A is executed in the power receiving apparatuses 102b and 102c in the same manner as the power receiving apparatus 102a.

FIG. 5B is a flowchart for explaining display process executed by the power supply apparatus 101 according to the first embodiment.

Assume that when the power supply apparatus 101 executes the display process, communication connections have already been established between the communication units 402a to 402c and the communication unit 202 of the power supply apparatus 101.

Also, assume that the power receiving apparatuses 102a to 102c have already started charging, and the charging time calculation unit 208 calculates elapsed times for the power receiving apparatuses 102a to 102c. As for a power receiving apparatus which has completed charging, the charging time calculation unit 208 calculates a time required until full charging.

When the power receiving apparatuses 102a to 102c execute the motion detection process shown in FIG. 5A, and when at least one of the power receiving apparatuses 102a to 102c has been moved, that apparatus which has been moved transmits the apparatus ID, motion information, and charging state information to the power supply apparatus 101. Note that the display process will be described below taking as an example a case in which the power receiving apparatus 102a has been moved.

The control unit 201 determines in step S511 whether or not the communication unit 202 receives the apparatus ID, motion information, and charging state information from one of the power receiving apparatuses 102a to 102c. If the control unit 201 determines that the communication unit 202 has received the apparatus ID, motion information, and charging state information, this process advances from step S511 to step S512. If the control unit 201 determines that the communication unit 202 has not received the apparatus ID, motion information, and charging state information, this process returns from step S511 to step S511.

In step S512, the control unit 201 stores the apparatus ID, motion information, and charging state information, which are received by the communication unit 202, in the storage unit 205 in association with each other. Note that when the apparatus ID, motion information, and charging state information have already been stored in the storage unit 205, the control unit 201 determines whether or not the apparatus ID received by the communication unit 202 matches that stored in the storage unit 205. When the apparatus ID received by the communication unit 202 matches that stored in the storage unit 205, the control unit 201 updates the motion information stored in the storage unit 205 by that received by the communication unit 202. In this case, the control unit 201 similarly updates the charging state information stored in the storage unit 205 by that received by the communication unit 202.

When the apparatus ID received by the communication unit 202 does not match that stored in the storage unit 205, the control unit 201 stores the apparatus ID, motion information, and charging state information received by the communication unit 202 in the storage unit 205. In this case, the apparatus ID, motion information, and charging state information received by the communication unit 202 are stored independently of those stored in the storage unit 205.

When the apparatus ID, motion information, and charging state information are stored in the storage unit 205, this process advances from step S512 to step S513.

In step S513, the control unit 201 supplies the charging state information received by the communication unit 202 in step S511 from the storage unit 205 to the charging state detection unit 207, and controls the charging state detection unit 207 to detect the charging states of the power receiving apparatuses 102a to 102c. The charging state detection unit 207 of the first embodiment detects the charging capacity of the rechargeable battery 409a of the power receiving apparatus 102a based on the charging state information, and supplies it to the control unit 201. The control unit 201 generates information required to display the charging capacity of the rechargeable battery 409a on the display unit 204 according to the charging capacity of the rechargeable battery 409a supplied from the charging state detection unit 207, and controls the display unit 204 to display that information. Note that the information required to display the charging capacity of the rechargeable battery 409a on the display unit 204 is information such as character data or an icon that indicates the charging capacity of the rechargeable battery 409a. Also, for example, when the display unit 204 includes three LEDs, and the charging capacity of the rechargeable battery 409a is full, the control unit 201 controls the display unit 204 to turn on all the three LEDs of the display unit 204. In this case, when the charging capacity of the rechargeable battery 409a is not full, the control unit 201 may control the display unit 204 to turn on the one or two LEDs of the display unit 204 in accordance with the charging capacity of the rechargeable battery 409a. When the charging capacity of the rechargeable battery 409a is smaller than a predetermined charging capacity, the control unit 201 may control the display unit 204 to turn on one LED of the display unit 204. When the charging capacity of the rechargeable battery 409a is equal to or larger than the predetermined charging capacity, the control unit 201 may control the display unit 204 to turn on the two LEDs of the display unit 204.

For example, when the display unit 204 includes one LED, the control unit 201 controls the display unit 204 to change an ON color of the LED of the display unit 204 in accordance with the charging capacity of the rechargeable battery 409a. In this case, when the charging capacity of the rechargeable battery 409a is full, the control unit 201 may control the display unit 204 to turn on the LED of the display unit 204 in orange. Also, in this case, when the charging capacity of the rechargeable battery 409a is not full, the control unit 201 may control the display unit 204 to turn on the LED of the display unit 204 in green.

For example, when the display unit 204 includes a display device such as a liquid crystal display, and can display character data, the apparatus ID and elapsed time may be displayed together with character data required to display the charging capacity of the rechargeable battery 409a. Note that the elapsed time is a time elapsed since transmission of the charging start information by the communication unit 202, which time is calculated by the charging time calculation unit 208. When the charging capacity of the rechargeable battery 409a is displayed on the display unit 204 as a charging state of the power receiving apparatus 102a, this process advances from step S513 to step S514.

In step S514, the control unit 201 outputs audio data via the audio output unit 206 as information indicating the charging capacity of the power receiving apparatus 102a. In this case, the control unit 201 outputs audio data according to the charging capacity of the rechargeable battery 409a, which is read out from the storage unit 205. In this case, for example, the control unit 201 may control the audio output unit 206 to output an audio message like “fully charged” or “50% charged” which indicates the charging capacity of the power receiving apparatus 102a. In this case, when the charging capacity of the rechargeable battery 409a is full, the control unit 201 may control the audio output unit 206 to output like “beep, beep”. Also, in this case, when the charging capacity of the rechargeable battery 409a is equal to or higher than 50%, the control unit 201 may control the audio control unit 206 to output like “beep-beep, beep-beep”. When the charging capacity of the rechargeable battery 409a is less than 50%, the control unit 201 may control the audio control unit 206 to output like “beep-beep-beep, beep-beep-beep”. When information that represents the charging state is output from the audio output unit 206, this process ends.

Assume that when the power receiving apparatus 102b or 102c has been moved, the power supply apparatus 101 executes the aforementioned display process shown in FIG. 5B in the same manner as in the case in which the power receiving apparatus 102a has been moved.

As described above, when the power receiving apparatus has detected a self motion, and transmits information indicating a charging state of the self apparatus to the power supply apparatus, the power supply apparatus according to the first embodiment displays the charging state of the power receiving apparatus. For this reason, for example, even when a plurality of power receiving apparatuses are simultaneously charged by the power supply apparatus, the user can confirm the charging state of a desired power receiving apparatus when he or she moves that apparatus.

Note that the charging capacity of the rechargeable battery displayed on the display unit 204 in step S513 is that corresponding to motion information received by the communication unit 202 from the power receiving apparatus in step S511. Also, the charging capacity of the rechargeable battery output from the audio output unit 206 in step S514 is that corresponding to the motion information received by the communication unit 202 from the power receiving apparatus in step S511.

### Second Embodiment

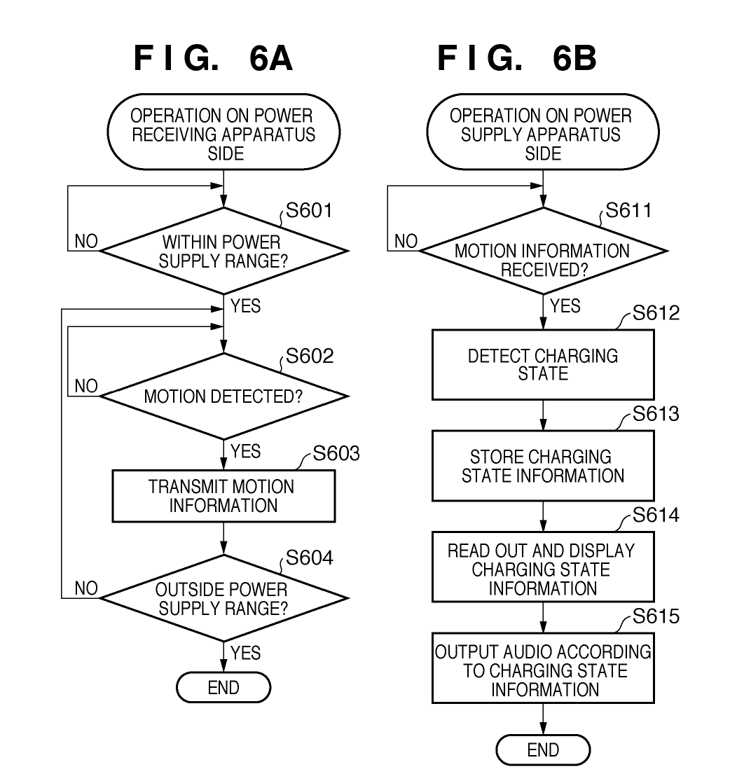

The flowchart which shows motion detection process to be executed by at least one of the power receiving apparatuses 102a to 102c according to the second embodiment and that which shows display process to be executed by the power supply apparatus 101 according to the second embodiment will be described below with reference to FIGS. 6A and 6B. In the second embodiment, descriptions common to the first embodiment will not be repeated, and differences from the first embodiment will be described.

In the second embodiment, assume that the storage unit 205 stores a charging state table which indicates the charging states of the power receiving apparatuses 102a to 102c. The charging state table is a data table which stores the apparatus IDs of the power receiving apparatuses 102a to 102c, power consumptions of the power receiving apparatuses as power supply targets detected by the charging state detection unit 207, and the charging states of the power receiving apparatuses 102a to 102c in association with each other. The charging state in the charging state table corresponds to one of states 1 to 4 shown in FIG. 3. The charging state table may be stored in advance in the storage unit 205 or the control unit 201 may generate that table according to the apparatus IDs acquired from the power receiving apparatuses 102a to 102c and the power consumptions detected by the charging state detection unit 207.

When the control unit 201 generates the charging state table, it may delete information such as the apparatus ID and power consumption associated with a power receiving apparatus, which does not receive a power supply start instruction from the power supply apparatus 101, from the charging state table. The control unit 201 deletes information such as the apparatus ID and power consumption associated with a power receiving apparatus, which does not receive a power supply start instruction from the power supply apparatus 101, from the charging state table.

FIG. 6A is a flowchart for explaining motion detection process executed by the power receiving apparatus 102 according to the second embodiment.

Since steps S601 and S602 in FIG. 6A are the same processes as in steps S501 and S502 in FIG. 5A, and step S604 in FIG. 6A is the same process as in step S505, a description thereof will not be repeated. Note that the following description will be given taking as an example a case in which the power receiving apparatus 102a executes the motion detection processing.

If the motion detection unit 406a has not detect any motion of the power receiving apparatus 102a in step S602, this process returns from step S602 to step S602. If the motion detection unit 406a has detected a motion of the power receiving apparatus 102a in step S602, this process advances from step S602 to step S603. In step S603, the control unit 401a reads out the apparatus ID stored in the storage unit 405a. The control unit 401a supplies the apparatus ID to the communication unit 402a together with motion information supplied from the motion detection unit 406a. The control unit 401a controls the communication unit 402a to transmit the apparatus ID and motion information to the power supply apparatus 101. When the communication unit 402a transmits the apparatus ID and motion information to the power supply apparatus 101 in step S603, this process advances from step S603 to step S604. The control unit 401a determines in step S604 whether or not it is detected that the power receiving apparatus 102a exists within the power supply range of the power supply apparatus 101. If the control unit 401a determines that the power receiving apparatus 102a exists within the power supply range, this process returns from step S604 to step S602. If the control unit 401a determines that the power receiving apparatus 102a does not exist within the power supply range, this process ends. Note that the aforementioned motion detection process shown in FIG. 6A is similarly executed in the power receiving apparatuses 102b and 102c as in the power receiving apparatus 102a.

FIG. 6B is a flowchart for explaining the display process to be executed by the power supply apparatus 101 according to the second embodiment.

When the motion detection processing shown in FIG. 6A is executed in the power receiving apparatuses 102a to 102c, and when at least one of the power receiving apparatuses 102a to 102c has been moved, that apparatus which has been moved transmits the apparatus ID and motion information to the power supply apparatus 101. Note that the display processing will be described below taking as an example a case in which the power receiving apparatus 102a has been moved.

Hence, the control unit 201 determines in step S611 whether or not the communication unit 202 has received the apparatus ID and motion information from one of the power receiving apparatuses 102a to 102c. If the control unit 201 determines in step S611 that the communication unit 202 has received the apparatus ID and motion information, this process advances from step S611 to step S612. If the control unit 201 determines that the communication unit 202 has not received any apparatus ID and motion information, this process returns from step S611 to step S611.

If the motion information has been received from the power receiving apparatus 102a, the control unit 201 detects a charging state of the power receiving apparatus corresponding to the apparatus ID received by the communication unit 202 in step S612. The charging state detection unit 207 detects power consumption consumed by the power receiving apparatus 102a corresponding to the apparatus ID. Hence, the control unit 201 refers to the charging state table stored in the storage unit 205 based on the apparatus ID and the power consumption detected by the charging state detection unit 207, thereby detecting the charging state of the power receiving apparatus 102a corresponding to the apparatus ID received by the communication unit 202. When the control unit 201 detects the charging state of the power receiving apparatus 102a corresponding to the apparatus ID received by the communication unit 202 in step S611, this process advances from step S612 to step S613.

In step S613, the control unit 201 stores the apparatus ID and motion information received by the communication unit 202, and charging state information as information indicating the charging state detected in step S612 in the storage unit 205 in association with each other. Note that when the apparatus ID, motion information, and information indicating the charging state have already been stored in the storage unit 205, the control unit 201 determines whether or not the apparatus ID received by the communication unit 202 matches that stored in the storage unit 205. When the apparatus ID received by the communication unit 202 matches that stored in the storage unit 205, the control unit 201 updates the motion information stored in the storage unit 205 by that received by the communication unit 202. In this case, the control unit 201 similarly updates the information indicating the charging state stored in the storage unit 205 by that detected in step S612.

When the apparatus ID received by the communication unit 202 does not match that stored in the storage unit 205, the control unit 201 stores the apparatus ID and motion information received by the communication unit 202 and the information indicating the charging state detected in step S612 in the storage unit 205. In this case, the apparatus ID and motion information received by the communication unit 202 and the information indicating the charging state detected in step S612 are stored in the storage unit 205 independently of those which have already been stored in the storage unit 205. When the control unit 201 stores the apparatus ID, motion information, and information indicating the charging state in the storage unit 205, this process advances from step S613 to step S614. Note that the control unit 201 generates information required to display the charging state of the rechargeable battery 409a on the display unit 204, and controls the display unit 204 to display this information in step S614. In this case, this process advances from step S614 to step S615.

In step S615, the control unit 201 controls the audio output unit 206 to output audio data indicating the charging state of the rechargeable battery 409a. In this case, this process ends.

Assume that when the power receiving apparatus 102b or 102c has been moved, the power supply apparatus 101 executes the aforementioned display process shown in FIG. 6B in the same manner as in the case in which the power receiving apparatus 102a has been moved.

Note that the information indicating the charging state of the rechargeable battery displayed on the display unit 204 in step S614 corresponds to the power receiving apparatus which transmitted the motion information to the communication unit 202 in step S611. Also, the information indicating the charging state of the rechargeable battery output from the audio output unit 206 in step S615 corresponds to the power receiving apparatus which transmitted the motion information to the communication unit 202 in step S611.

As described above, when the power receiving apparatus has detected a motion of itself, the power supply apparatus according to the second embodiment detects and displays a charging state of that power receiving apparatus. For this reason, as in the first embodiment, for example, even when a plurality of power receiving apparatuses are placed on the power supply area of the power supply apparatus, the user can confirm the charging state of a desired power receiving apparatus by moving that apparatus on the power supply area.

Note that in the second embodiment, since the power receiving apparatuses 102a to 102c need not detect charging states of the rechargeable batteries 409a to 409c, they need not have the charging state detection units 407a to 407c.

### Other Embodiments

Note that the above embodiments have exemplified the arrangement in which electric power is supplied to the power receiving apparatus 102 which is placed to be in contact with the power supply area 103 of the power supply apparatus 101. However, when a power supply method such as a resonant magnetic coupling type or electromagnetic induction type, which can supply electric power even when the power supply apparatus 101 and power receiving apparatus 102 are separated, is adopted, the power receiving apparatus 102 need not be in contact with the power supply area 103.

Aspects of the present invention can also be realized by a computer of a system or apparatus (or devices such as a CPU or MPU) that reads out and executes a program stored on a memory device to perform the functions of the above-described embodiment(s), and by a method, the steps of which are performed by a computer of a system or apparatus by, for example, reading out and executing a program stored on a memory device to perform the functions of the above-described embodiment(s). For this purpose, the program is provided to the computer for example via a network or from a storage medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-150260, filed on Jun. 30, 2010, which is hereby incorporated by reference herein its entirety.

What is claimed is:

1. A power supply apparatus for supplying electric power wirelessly to a power receiving apparatus which charges a battery, the power supply apparatus comprising:
a detection unit that detects whether or not the power receiving apparatus is moved based on motion information associated with a motion of the power receiving apparatus; and
a control unit that controls an informing unit to inform remaining capacity information indicating a remaining capacity of the battery if it is detected that the power receiving apparatus is moved, wherein the motion information and the remaining capacity information are obtained from the power receiving apparatus.

2. The power supply apparatus according to claim 1, wherein if it is detected that the power receiving apparatus is moved, the informing unit informs the remaining capacity information by using one of character data, audio data, and an icon.

3. A power supply apparatus for supplying electric power wirelessly to a first power receiving apparatus and a second power receiving apparatus, the power supply apparatus comprising:
a detection unit that detects whether or not the first power receiving apparatus is moved based on first motion information associated with a motion of the first power receiving apparatus, and detects whether or not the second power receiving apparatus is moved based on second motion information associated with a motion of the second power receiving apparatus; and
a control unit that controls an informing unit to inform first remaining capacity information indicating a remaining capacity of a first battery if it is detected that the first power receiving apparatus is moved and the second power receiving apparatus is not moved, wherein the first motion information and the first remaining capacity information are obtained from the first power receiving apparatus, the second motion information is obtained from the second power receiving apparatus, the first power receiving apparatus charges the first battery, and the second power receiving apparatus charges a second battery.

4. The power supply apparatus according to claim 3, wherein if it is detected that the first power receiving apparatus is moved and the second power receiving apparatus is not moved, the informing unit informs the first remaining capacity information by using one of character data, audio data, and an icon.

5. The power supply apparatus according to claim 3, wherein the control unit controls the informing unit to inform second remaining capacity information indicating a remaining capacity of the second battery if it is detected that the second power receiving apparatus is moved and the first power receiving apparatus is not moved.

6. The power supply apparatus according to claim 5, wherein if it is detected that the second power receiving apparatus is moved and the first power receiving apparatus is not moved, the informing unit informs the second remaining capacity information by using one of character data, audio data, and an icon.

7. A power supply system comprising:
a power receiving apparatus that charges a battery; and
a power supply apparatus that supplies electric power wirelessly to the power receiving apparatus, wherein the power receiving apparatus includes a motion detection unit that detects motion information associated with a motion of the power receiving apparatus,
the power supply apparatus includes:
a detection unit that detects whether or not the power receiving apparatus is moved based on the motion information and a control unit that controls an informing unit to inform remaining capacity information indicating a remaining capacity of the battery if it is detected that the power receiving apparatus is moved, and the power supply apparatus obtains the motion information and the remaining capacity information from the power receiving apparatus.

8. A power supply system comprising:
a first power receiving apparatus that charges a first battery;
a second power receiving apparatus that charges a second battery; and
a power supply apparatus that supplies electric power wirelessly to the fist power receiving apparatus and the second power receiving apparatus, wherein the first power receiving apparatus includes a first motion detection unit that detects first motion information associated with a motion of the first power receiving apparatus, the second power receiving apparatus includes a second motion detection unit that detects second motion information associated with a motion of the second power receiving apparatus, the power supply apparatus includes: a detection unit that detects whether or not the first power receiving apparatus is moved based on the first motion information, and detects whether or not the second power receiving apparatus is moved based on the second motion information and a control unit that controls an informing unit to inform first remaining capacity information indicating a remaining capacity of the first battery if it is detected that the first power receiving apparatus is moved and the second power receiving apparatus is not moved, wherein the power supply apparatus obtains the first motion information and the first remaining capacity information from the first power receiving apparatus, and the power supply apparatus obtains the second motion information from the second power receiving apparatus.

9. A method of controlling a power supply apparatus, the method comprising:
supplying electric power wirelessly to a power receiving apparatus which charges a battery;
obtaining motion information associated with a motion of the power receiving apparatus from the power receiving apparatus;
detecting whether or not the power receiving apparatus is moved based on the motion information;
obtaining remaining capacity information indicating a remaining capacity of the battery from the power receiving apparatus; and
controlling an informing unit to inform the remaining capacity information if it is detected the power receiving apparatus is moved.

10. A method of controlling a power supply apparatus, the method comprising:
supplying electric power wirelessly to a first power receiving apparatus and a second power receiving apparatus;
obtaining first motion information associated with a motion of the first power receiving apparatus from the first power receiving apparatus;
obtaining second motion information associated with a motion of the second power receiving apparatus from the second power receiving apparatus;
detecting whether or not the first power receiving apparatus is moved based on the first motion information;
detecting whether or not the second power receiving apparatus is moved based on the second motion information;
obtaining first remaining capacity information indicating a remaining capacity of a first battery from the first power receiving apparatus; and
controlling an informing unit to inform the first remaining capacity information if it is detected that the first power receiving apparatus is moved and the second power receiving apparatus is not moved, wherein the first receiving apparatus charges the first battery, and the second receiving apparatus charges a second battery.

11. A non-transitory storage medium storing a program executed by a computer, the program controlling the computer to execute a method of controlling a power supply apparatus, the method comprising:
supplying electric power wirelessly to a power receiving apparatus which charges a battery;
obtaining motion information associated with a motion of the power receiving apparatus from the power receiving apparatus;
detecting whether or not the power receiving apparatus is moved based on the motion information;
obtaining remaining capacity information indicating a remaining capacity of the battery from the power receiving apparatus; and
controlling an informing unit to inform the remaining capacity information if it is detected the power receiving apparatus is moved.

12. A non-transitory storage medium storing a program executed by a computer, the program controlling the computer to execute a method of controlling a power supply apparatus, the method comprising:
supplying electric power wirelessly to a first power receiving apparatus and a second power receiving apparatus;
obtaining first motion information associated with a motion of the first power receiving apparatus from the first power receiving apparatus;
obtaining second motion information associated with a motion of the second power receiving apparatus from the second power receiving apparatus;
detecting whether or not the first power receiving apparatus is moved based on the first motion information;
detecting whether or not the second power receiving apparatus is moved based on the second motion information;
obtaining first remaining capacity information indicating a remaining capacity of a first battery from the first power receiving apparatus; and
controlling an informing unit to inform the first remaining capacity information if it is detected that the first power receiving apparatus is moved and the second power receiving apparatus is not moved, wherein the first receiving apparatus charges the first battery, and the second receiving apparatus charges a second battery.
